(19) United States
(12) Patent Application Publication
(10) Pub. No.: US 2012/0239874 A1
(43) Pub. Date: Sep. 20, 2012

(54) METHOD AND SYSTEM FOR RESOLVING INTEROPERABILITY OF MULTIPLE TYPES OF DUAL IN-LINE MEMORY MODULES

(75) Inventors: Hyun Lee, Ladera Ranch, CA (US); Jayesh R. Bhakta, Cerritos, CA (US); Paresh Sheth, Chino Hills, CA (US)

(73) Assignee: NETLIST, INC., Irvine, CA (US)

(21) Appl. No.: 13/411,344

(22) Filed: Mar. 2, 2012

Related U.S. Application Data
(60) Provisional application No. 61/448,590, filed on Mar. 2, 2011.

(51) Int. Cl. G06F 12/00

(52) U.S. Cl. 711/105

(57) ABSTRACT

Systems and methods are described for resolving certain interoperability issues among multiple types of memory modules in the same memory subsystem. The system provides a single data load DIMM for constructing a high density and high speed memory subsystem that supports the standard JEDEC RDIMM interface while presenting a single load to the memory controller. At least one memory module includes one or more DRAM, a bi-directional data buffer and an interface bridge with a conflict resolution block. The interface bridge translates the CAS latency (CL) programming value that a memory controller sends to program the DRAMs, modifies the latency value, and is used for resolving command conflicts between the DRAMs and the memory controller to insure proper operation of the memory subsystem.

### CROSS-REFERENCE TO RELATED APPLICATIONS

This application claims the benefit of priority to U.S. Provisional Appl. No. 61/448,590, filed Mar. 2, 2011 and incorporated in its entirety by reference herein.

### BACKGROUND OF THE INVENTION

1. Field of the Invention

The subject of this application generally relates to the field of memory systems, and, more particularly, to a memory subsystem including one or more dual in-line memory modules (DIMMs).

2. Description of the Related Art

When an application or a usage model of a system specifies higher density or faster memory access than the memory subsystem is originally architected for by a system designer, two contradictory issues generally arise. The first issue is in regards to the density and speed, as the relationship between the density and speed generally follows an inverse function to each other. The higher density of the memory subsystem translates to a heavier load on the address, command, and data lines, and thus resulting in a slower speed of the memory subsystem. The second issue relates to the power dissipation by the memory subsystem, where the power dissipation increases as the density and speed of the memory subsystem increase.

### SUMMARY

In certain embodiments, a method is provided to interface a memory module to a memory controller. The memory module comprises a plurality of programmable memory devices and an interface bridge. The interface bridge is configured to receive from the memory controller any one of a first read command, a first write command, and a first programming command. The method comprises the interface bridge determining a first and second latency delay values. The method further comprises the interface bridge receiving a first read command issued by the memory controller to the memory module, wherein the first read command is stored by the interface bridge. The method further comprises the interface bridge transmitting to the plurality of memory devices the first read command, wherein the transmitting of the first read command is delayed using the first latency delay value. The method further comprises the interface bridge receiving a first write command issued by the memory controller to the memory module, wherein the first write command is stored by the interface bridge. The method further comprises the interface bridge transmitting to the plurality of memory devices the first write command, wherein the transmitting of the first write command is delayed using the second latency delay value.

In certain embodiments, a memory module is provided which comprises an interface bridge configured to receive from a memory controller a first programming command to program a first latency value into a plurality of programmable memory devices. The first programming command includes the first latency value. The interface bridge is further configured to generate a second latency value, wherein the second latency value is less than the first latency value. The interface bridge is further configured to program the second latency value into the plurality of programmable memory devices.

In certain embodiments, a method is provided to interface a memory controller to a first and second memory modules. The first memory module comprises a first plurality of programmable memory devices and a first interface bridge. The first interface bridge is configured to receive from the memory controller any one of a first read command and a first write command. The second memory module comprises a second plurality of programmable memory devices and a second interface bridge. The second interface bridge is configured to receive from the memory controller any one of a second read command and a second write command. The method comprises determining a first latency delay value for the first read command, wherein the first read command is (i) issued by the memory controller to the first memory module, and (ii) stored by the first interface bridge. The method further comprises the first interface bridge transmitting the first read command to the first plurality of programmable memory devices, wherein the transmitting of the first read command to the first plurality of programmable memory devices is delayed using the first latency delay value. The method further comprises determining a second latency delay value for the first write command, wherein the first write command is (i) issued by the memory controller to the first memory module, and (ii) stored by the first interface bridge. The method further comprises the first interface bridge transmitting the first write command to the first plurality of programmable memory devices, wherein the transmitting of the first write command to the first plurality of programmable memory devices is delayed using the second latency delay value. The method further comprises the second interface bridge receiving and storing any one of the second read command and the second write command, wherein the memory controller issues any one of the second read command and the second write command to the second memory module. The method further comprises the second interface bridge transmitting any one of the second read command and the second write command to the second plurality of programmable memory devices, wherein the transmitting of any one of the second read command and the second write command to the second plurality of programmable memory devices is delayed using a third latency delay value.

### BRIEF DESCRIPTION OF THE DRAWINGS

FIG. 1 illustrates an example memory subsystem write operation.

FIG. 2 illustrates an example memory subsystem read operation.

FIG. 3 illustrates an example memory subsystem write operation using a memory buffer.

FIG. 4 illustrates an example memory subsystem read operation using a memory buffer.

FIG. 5 includes a table of example DDR3 DRAM operating latency parameters.

FIG. 6 includes a table of example configurable latencies for DDR3 DRAM operating at 1333 MTs.

FIG. 7 illustrates an example memory subsystem with modified write delay in accordance with one embodiment.

FIG. 8 illustrates an example memory subsystem with modified read delay in accordance with one embodiment.

FIGS. 9A and 9B illustrate an example memory subsystem with command conflict in accordance with one embodiment.

FIGS. 10A and 10B illustrate an example memory subsystem with command conflict resolution block in accordance with one embodiment.

### DETAILED DESCRIPTION

While there are solutions addressing the higher density, speed, and the power dissipation of a memory subsystem, such solutions rarely address the issue that a memory controller expects the behavior of all the storage systems (DIMMs) that are under its control to be identical to ensure proper operation at a desired (e.g., maximum) throughput rate. It is therefore desirable to provide memory subsystems the ability to resolve interoperability of multiple types of DIMMs by supporting the standard interface between memory subsystem units and the memory controller while providing solution to these density, speed, and power issues.

Furthermore, there is a need to expand the addressable memory space in a memory subsystem. It is further desirable to expand the addressable memory space without hardware or software changes to the existing system, and having a minimum impact on system performance.

One challenge is that this type of interface logic can add latency delays to the memory access time, which can cause violation of DDR3 RDIMM JEDEC standard. For example, assuming that a memory controller expects seven cycles column address select (CAS) latency for a write operation, and is aware that a delay of two cycles exists through an interface bridge, then the dynamic random-access memories (DRAM) in the memory subsystem should be programmed with a seven cycle write CAS latency. Therefore, the memory controller must send its write data to the dynamic random-access memories (DRAM) nine cycles later after it issues the write command. In other words, because the write command would arrive at the DRAM two cycles after it was issued by the memory controller and the DRAM expect the write data corresponding to the write command to arrive seven cycles later, then for a successful write operation the memory controller must send the write data nine cycles later from the time the write command was issued. Thus, from the point of view of the memory controller, the DRAM are operated as if the write CAS latency is nine cycles.

Because programming different values for write CAS latency to the DRAM than the controller is the same as programming a different operating frequency to the DRAM than to the memory controller, these types of write CAS latency mismatches between how the memory controller operates and how the DRAM are programmed to operate would lead to a violation of the JEDEC standard, e.g. DDR3 Registered Dual In-Line Memory Module (RDIMM) specification controller. Taking the same example above, a similar problem would also exists for the read operation, since different read latencies would need to be programmed in DRAM to account for additional latency through the interface bridge as a memory controller executes a read operation.

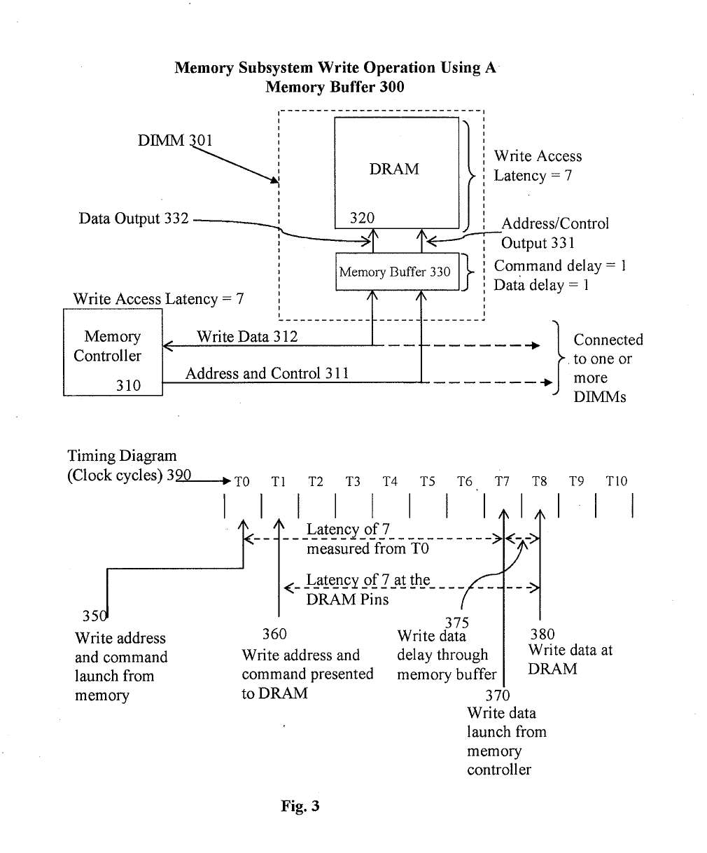

There are a number of proposed solutions to handle the DDR3 write CAS latency violation issue by implementing the same number of latency cycles to the data path as to the command/address path, see FIG. 3. This type of solution is referred to as a memory buffer solution and it is different from the industry standard DDR3-Registered DIMM solution where only the Address, and Control 311 signals are buffered while the data signals are not buffered. However, a memory buffer as presented in these solutions adds the same latency to both the address and data paths. For example, a memory buffer samples or registers the address, control, and data signals, and hence those signals are propagated with one cycle latency. During the write operation, both address and data signals arrive at the DRAM one cycle late, and operation would conclude successfully although one cycle late. During the read operation, the address and control signals arrive one cycle late, the DRAM respond to the read command by driving its read data to the memory buffer where the read data arrives at the memory controller one cycle later. Therefore, in this example it is expected that while executing a read operation, the read latency increases by twice the write latency, e.g. two cycles versus one cycle.

Therefore, although these types of solutions allow an increase of the memory subsystem space, there are a number of incompatibility issues with the industry standard protocol. First, the additional read latency is twice of the additional write latency since the read data return path from DRAM goes through the similar delay path as the command/address/control delay through the interface bridge. Second, as the number of the delay pipeline stages increases, the difference between the write access latency and the read access latency increases. This is especially a troublesome issue in DDR3 technology since the DDR3 memory subsystem operation is an asynchronous operation in which memory operation is based on the time (e.g., nanoseconds) and not the latency number in clock cycles, which causes additional data delay compared to the standard case. Third, due to a large difference between the read latency vs. the write latency, it is sometimes not possible for the controller to configure the memory subsystem for desired (e.g., optimum) operation.

Using an example memory subsystem such as, a DDR3 server memory subsystem, it is particularly true that a memory controller expects the behavior of all the storage systems that are under its control to be identical to ensure proper operation at a desired (e.g., maximum) throughput rate. In order to meet the controller's expectation and supporting the standard interface between memory subsystem units and the memory controller while providing solution to these density, speed, and power issues. Since the memory subsystem protocol follows strict industry standards, an interface logic that bridges memory subsystem units to/from the memory controller, may employ memory protocol translation to seamlessly expand the memory controller's addressable memory space.

In accordance with one embodiment, a method of increasing the addressable memory space in a DDR3 based memory subsystem without changes to the memory controller hardware or software including basic input/output system (BIOS) or Memory initialization Reference Code (MRC) while reducing or minimizing the added latency through an interface bridge, which bridges the expanded memory storage units to/from the existing memory controller.

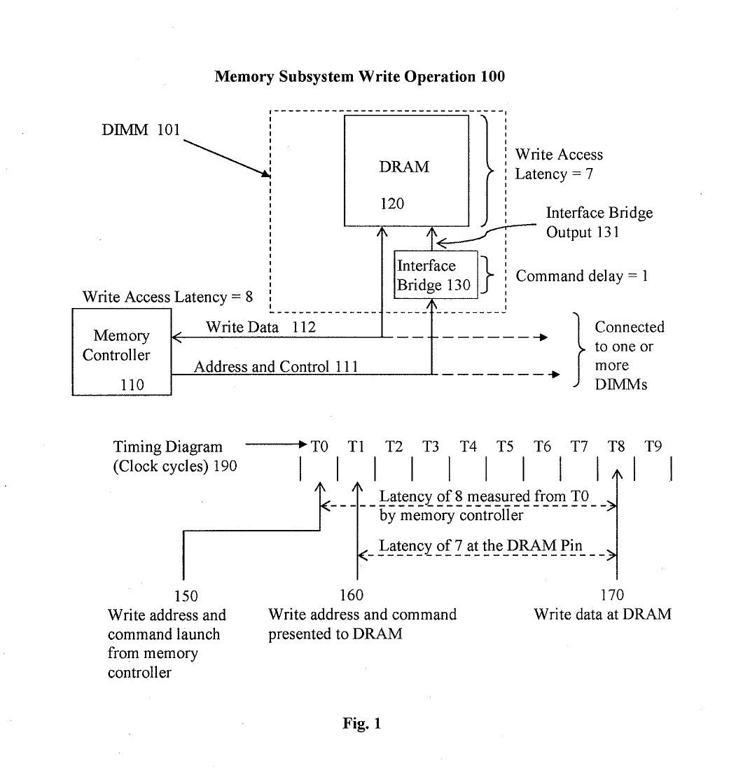

For example, in accordance with a DDR3 RDIMM Joint Electron Devices Engineering Council (JEDEC) standard DDR3 Register, an example Memory Subsystem Write Operation 100 is shown in FIG. 1. The memory subsystem topology includes a memory module DIMM 101 that include DRAM 120 and an Interface Bridge 130. The operational timing is shown in this figure, and some operational parameters. The Interface Bridge 130 introduces a one clock delay to the Address and Control 111 before sending the write command and address signals to DRAM 120. The standard JEDEC RDIMM operation specifies a DDR3 Register that receives and buffers address/command/control signals at a rising edge of the clock, and drives them to the DRAM 120 on the next rising edge of the clock, such that a read or write command is delayed by one clock cycle. Thus the DDR3 Register inserts a clock cycle to the address/command/control path. The DDR3 Register is shown as the Interface Bridge 130 in FIG. 1.

A DDR3 compliant Memory Controller 110 is designed to support this latency through the Interface Bridge 130 such that it automatically inserts a delay cycle to the Write Data 112 such that it accounts or compensates for the one cycle latency delay through the Interface Bridge 130. In other words, the Memory Controller 110 delays one clock cycle the transmission of its Write Data 112 to the DRAM 120. The Timing Diagram 190 illustrates this example of a write operation procedure. Prior to Time T0, the Memory Controller 110 programs the DRAM 120 with write access latency value equals seven clock cycles, to set the operation speed at 1333 MT/s. The Memory Controller 110 issues a write command at T0 150 (labeled with “Write address and command launch from memory controller”). The Interface Bridge 130 receives the Address and Control 111 signals during T0 150, and sends them to DRAM 120 during T1 160 (labeled “Write address and command presented to DRAM”). The Memory Controller 110 sends the Write Data 112 arriving at DRAM 120 pins during T8 170 (labeled “Write data at DRAM”). Since the DRAM 120 were programmed with a latency value of seven clock cycles, then the DRAM 120 expects the Write Data 112 to arrive seven clock cycles after the write command was received by the DRAM 120 at T1 160. Therefore, the write operation completes successfully by writing the data at the DRAM 120, meeting the timing of DDR3 RDIMM write operation in accordance with the DDR3 RDIMM JEDEC standard protocol.

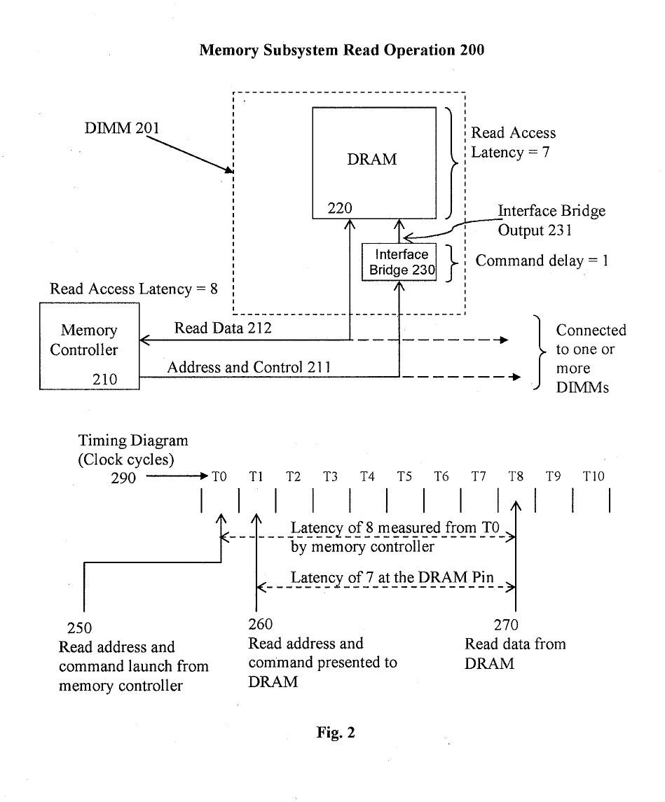

An example Memory Subsystem Read Operation 200 is shown in FIG. 2. The memory subsystem topology is same as shown in FIG. 1, with DIMM 201, Memory Controller 210, DRAM 220, and Interface Bridge 230. Following a standard read operation with a read access latency of seven cycles, the Memory Controller 210 is designed to support this latency through the Interface Bridge 230 such that it automatically expects the read data to arrive with a one clock cycle delay, this is the case in order to accounts for the one cycle latency through the Interface Bridge 230. The operational timing for the read operation is shown in Timing Diagram 290. Prior to Time T0 250, the Memory Controller 210 programs the DRAM 220 with a read access latency value equals to seven clock cycles, where the speed of DRAM operation is not dependent on the ‘read latency’ number. The Memory Controller 210 issues a read command at T0 250 (labeled “Read address and command launch from memory controller”). The Interface Bridge 230 presents the Address and Control 211 to the DRAM 220 at T1 260 (labeled “Read address and command presented to DRAM”). Since the DRAM 220 are programmed with read latency of seven clock cycles, then the DRAM 220 outputs Read Data 212 at T8 270, and the Memory Controller 210 expected to receive the Read Data 212 at T8 (labeled “Read data from DRAM”) since it is aware that the programmed read latency is seven and one additional cycle delay through the Interface Bridge 230 would results in total read latency of eight cycles. Therefore, the read operation completes successfully meeting the timing of DDR3 RDIMM read operation in accordance with the DDR3 RDIMM JEDEC standard protocol.

An example Memory Subsystem Write Operation Using A Memory Buffer 300 is shown in FIG. 3. A memory subsystem comprises DIMM 301 including DRAM 320 and a Memory Buffer 330. The write operation is implemented using a memory buffer. One aspect of this architecture is to add the same amount of latency to the address, command, and control signals paths as the data signal path, such that any command from the Memory Controller 310 to the DRAM 320 would be delayed by one cycle, and any data from/to the Memory Controller 310 to/from the DRAM 320 would also be delayed by one cycle. This architecture uses a Memory Buffer 330 that includes a Register similar to the Interface Bridge 130 of FIG. 1 or the Interface Bridge 230 of FIG. 2. The Memory Buffer 330 delays by one clock cycle the address, command, and control path as well as the write and read data path from and to the DRAM 320. A Memory Controller 310 accesses the DRAM 320 in a similar fashion as the JEDEC standard UDIMM operation procedure, where the Memory Controller 310 does not compensate the address, command, and control path delay through the memory buffer.

The Timing Diagram 390 shows a write operation procedure. Prior to Time T0 350, the Memory Controller 310 programs the DRAM 320 with write access latency value equals to seven clock cycles, and set the operation speed at 1333 MT/s. The Memory Controller 310 issues a write command at T0 350 (labeled “Write address and command launch from memory controller”), and sends the write data at T7 370 (labeled “Write data launch from memory controller”) according to the DDR3 JEDEC standard protocol. However, the Write Data 312 arrives at the DRAM 320 at T8 380 because of the one clock delay 375 through the Memory Buffer 330 (labeled “Write data delay through memory buffer”). Since the DRAM 320 were programmed with a latency value of seven and the DRAM 320 received the write command at T1, then the DRAM 320 expects to receive the Write Data 312 at T8 380 (labeled “Write data at DRAM”). Thus, the timing relationship between the Write Data 312 and Address and Control 311 is maintained correctly at the DRAM 320 input pins and the write operation completes successfully.

An example Memory Subsystem Read Operation Using A Memory Buffer 400 is shown in FIG. 4. Similarly to the write operation described above, the memory subsystem read operation is described using a DIMM 401, a Memory Controller 410, DRAM 420, and a Memory Buffer 430. The memory subsystem topology is similar to the one shown in FIG. 3, and the operational timing is shown in Timing Diagram 490. The Memory Controller 410 accesses the DRAM 420 in a similar fashion as the JEDEC standard UDIMM operation procedure, where the Memory Controller 410 does not compensate for the address, command, and control path delay through the memory buffer. The Timing Diagram 490 shows a read operation procedure. Prior to time T0 450, the Memory Controller 410 programs the DRAM 420 with read access latency value equals to seven cycles, where the speed of DRAM 320 operation is not dependent on the read latency value. The Memory Controller 410 issues a read command at T0 450 (labeled “Read address and command launch from memory controller”). The DRAM 420 receives the read command at T1 460 (labeled “Read address and command presented to DRAM”). The DRAM 420 outputs the read data seven clock cycles later at T8 470 (labeled “Read data at DRAM”). The Memory Buffer 430 receives the read data and drives Read Data 412 to the Memory Controller 410 at T9 480 (labeled “Read data at the memory controller”). However, the Memory Controller 410 is expecting to receive the Read Data 412 at T7. Thus, the read operation does not complete successfully and hence is not compliant with the JEDEC standard, e.g., UDIMM or RDIMM operation, because unlike the write operation, the read operation encounters two additional latency cycles: one latency at the Address/Control Output 431, and one latency 475 from the read data path through the Memory Buffer 430 (labeled “Read data delay through memory buffer”).

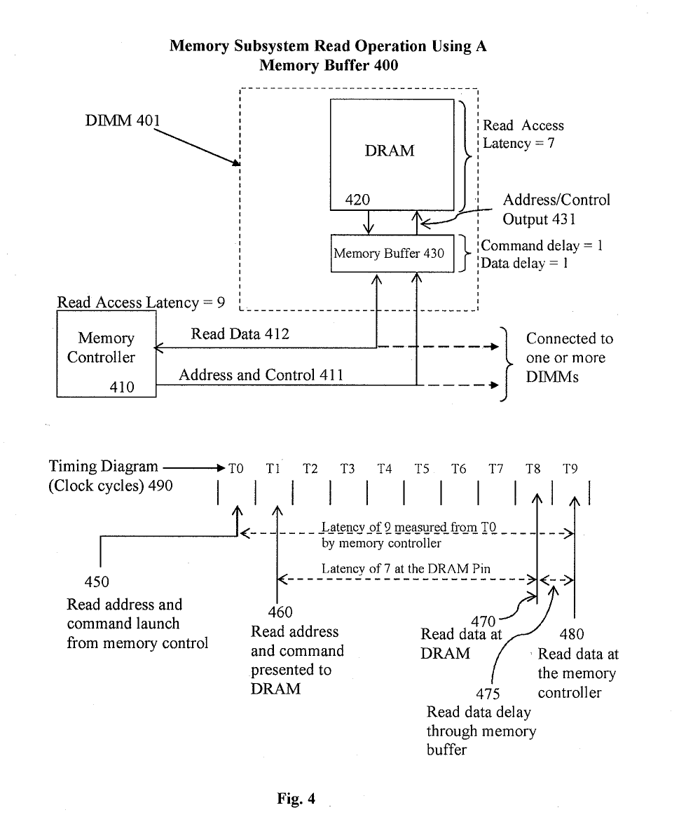

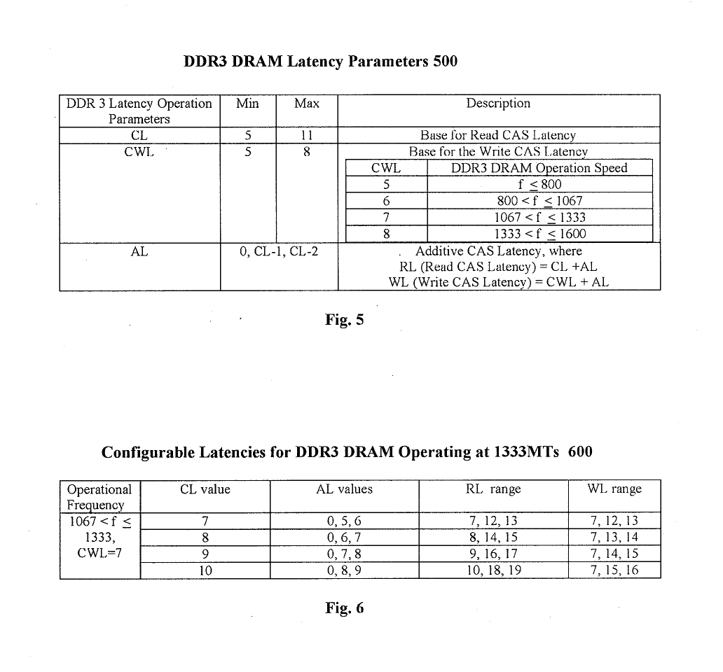

Various values for DDR3 DRAM Latency Parameters 500 are shown in FIG. 5. Configurable latencies values are shown in FIG. 6 for DDR3 DRAM Operating at 1333 MT/s speed 600. Both figures show the importance of configuring a JEDEC compliant memory controller and DRAM with the same write latency number (CWL). If the CWL value in a memory controller is different than the CWL in the DRAM, then the DRAM expect an input clock frequency that is different from what the memory controller supplies and hence likely causing a system failure. Similarly, the configurable read latency (RL) could have different values depending on the additive latency (AL) and CAS latency (CL), such that RL=CL+AL and WL=CWL+AL. For example, as shown in the first row of FIG. 6, if CWL is seven and CL is seven, then the possible configurable AL varies from zero, five, or six. Therefore the read latency RL would also vary from seven, twelve, or thirteen. This means that if the latency through an interface bridge is greater than zero, then the next possible configurable value for the read latency RL is twelve, and this imposes a great degradation to the performance of the memory subsystem.

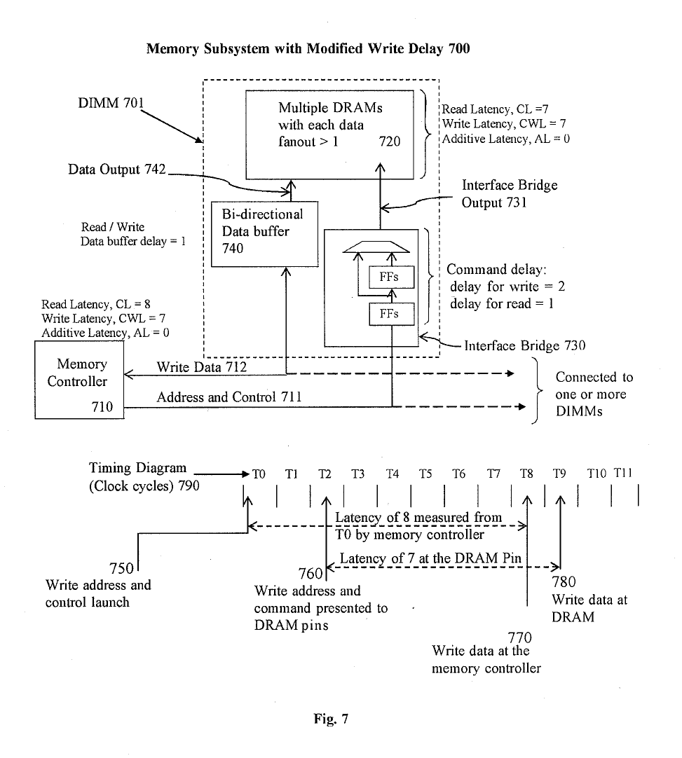

In accordance with one embodiment, a Memory Subsystem with Modified Write Delay 700 is shown in FIG. 7. The example memory subsystem's operational timing is shown in Timing Diagram 790. Unlike the JEDEC standard RDIMM or other previous techniques, in this embodiment, an additional latency cycle is added to the address and command path only during a write operation but not during the read operation. As a result, the read path would experience one cycle delay through an Interface Bridge 730 and one cycle delay through a Bi-Directional Data Buffer 740, while the write path would experience two cycles delay through the Interface Bridge 730 and one cycle delay through the Bi-Directional Data Buffer 740. This hybrid architecture advantageously allows a memory module DIMM 701 to operate as a standard JEDEC RDIMM without any hardware or software changes, or at least without any significant hardware or software changes to the Memory Controller 710.

In accordance with one embodiment, the memory subsystem includes a memory module DIMM 701 comprising DRAM 720 (e.g., a plurality of DRAM devices, each having more than one data fanout), the Interface Bridge 730, and the Bi-Directional Data Buffer 740. The Interface Bridge 730 selectively inserts a latency of two cycles to the write path but a latency of only one cycle to the read path. For example, upon receiving a read command, the Interface Bridge 730 selects the output of the first stage flip-flops (FFs) to drive the Interface Bridge Output 731 to the DRAM 720. However, upon receiving a write command, the Interface Bridge 730 select the output of the second stage FFs to drive its Interface Bridge Output 731 to the DRAM 720, hence additional one cycle latency to the write path in comparison with the read path. The two stage FFs is an implementation example, and persons skilled in the art would know how to implement this architecture using a variety of different types of designs and implementations. As discussed above for the memory buffer, the Bi-Directional Data Buffer 740 adds one cycle latency delay to the Write Data 712 received from the Memory Controller 710 and is to be driven to the DRAM 720 via its Data Output 742. This proposed architecture supports the standard JEDEC RDIMM write protocol as will be described below.

The Timing Diagram 790 helps in the description of a write operation procedure in accordance with one embodiment. In this example and prior to time T0 750, the Memory Controller 710, which is an RDIMM compliant memory controller, programs the DRAM 720 with a write access latency of seven cycles and set the operation speed at 1333 MT/s. The Memory Controller 710 launches a write command at T0 750 (labeled “Write address and control launch”). The Interface Bridge 730 presents the write command to the DRAM 720 at T2 760 (labeled “Write address and command presented to DRAM pins”). The DRAM 720 expect to receive the Write Data 712 seven cycles later at T9 780 (labeled “Write data at DRAM”). The Memory Controller 710 outputs its Write Data 712 at T8 770 (labeled “Write data at the memory controller”), because the Memory Controller 710 is accounting for the seven cycle latency programmed in the DRAM 720 and one cycle latency it is expecting from the Interface Bridge 730, as per JEDEC RDIMM standard write operation. The Write Data 712 is received by the Bi-Directional Data Buffer 740 which in turn outputs the Write Data 712 using Data Output 742 to the DRAM 720 at T9 780. Therefore, the standard JEDEC RDIMM write operation is supported and the write operation completes successfully without any changes, or at least without any significant changes, to the memory controller.

In a standard JEDEC RDIMM configuration, a memory subsystem may include multiple memory modules and each may include one or more of the Interface Bridge 730 residing on each memory module, DIMM 701. In accordance with one embodiment, the address and control pins of the DRAM 720 on each DIMM 701 are driven by one or more Interface Bridge 730. This configuration can support higher operation speed by relieving the Address and Control 711 load on the Memory Controller 710. Similarly, as the number of DRAM 720 increases, the Write Data 712 load on the Memory Controller 710 becomes very significant. Since the Bi-Directional Data Buffer 740 is advantageously used to re-drive the Write Data 712 signals, the load of the DRAM 720 data path is isolated from the Memory Controller 710, which advantageously affects the memory subsystem operational speed. In accordance with one embodiment, the Bi-Directional Data Buffer 740 reduces the data load on the Memory Controller 710 and thus increases the performance by allowing an increase in the Write Data 712 switching rate.

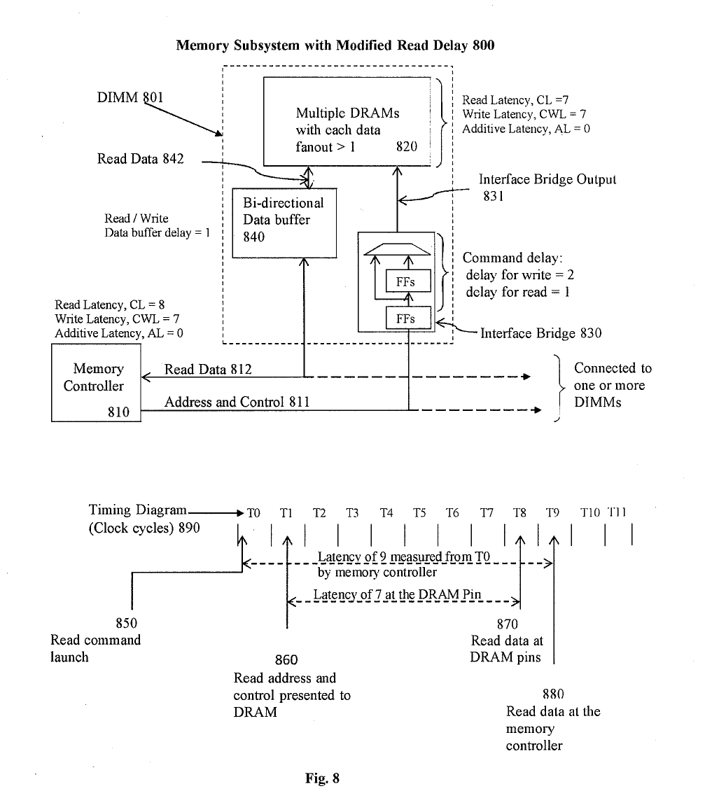

In accordance with one embodiment, a Memory Subsystem with Modified Read Delay 800 is shown in FIG. 8. The example memory subsystem's operational timing is shown in Timing Diagram 890. In this embodiment, the read operation encounter a normal latency of one cycle, as compared with a latency of two cycles for the write operation as described above. This hybrid architecture advantageously allows a memory module DIMM 801 to operate as a standard JEDEC RDIMM without any hardware or software changes, or at least without any significant hardware or software changes to the Memory Controller 810.

In accordance with one embodiment, the memory subsystem includes a DIMM 801 comprising DRAM 820 (e.g., a plurality of DRAM devices, each having more than one data fanout), an Interface Bridge 830, and a Bi-Directional Data Buffer 840. The Interface Bridge 830 selectively inserts an additional latency cycle to the write path in comparison with the read path. Upon receiving a read command, the Interface Bridge 830 selects the output of the first stage FFs to drive its Interface Bridge Output 831 to the DRAM 820. However, upon receiving a write command, the Interface Bridge 830 select the output of the second stage FFs to drive its Interface Bridge Output 831 to the DRAM 820. Therefore, a latency of one cycle is inserted into the read path, while a latency of two cycles is inserted into the write path. The Bi-Directional Data Buffer 840 adds one cycle latency delay to the Read Data 842 received from the DRAM 820 and is to be driven as Read Data 812 to the Memory Controller 810. This proposed architecture supports the standard JEDEC RDIMM write protocol as will be described below.

The Timing Diagram 890 helps in the description of a read operation procedure in accordance with one embodiment. In this example and prior to time T0 850, the Memory Controller 810, which is an RDIMM compliant memory controller, programs the DRAM 820 with a read access latency of eight cycles and set the operation speed at 1333 MT/s. The Interface Bridge 830 subtracts one from this read latency number, and actually programs the DRAM 820 with read access latency of seven cycles.

The Memory Controller 810 launches a read command at T0 850 (labeled “Read command launch”). The Interface Bridge 830 only inserts a latency of one cycle and presents the write command to the DRAM 820 at T1 860 (labeled “Read address and control presented to DRAM”). The DRAM 820 output the Read Data 842 seven cycles later at T8 870 (labeled “Read data at DRAM pins”) because they were programmed by the Interface Bridge 830 using a read latency of seven cycles. The Read Data 842 is in turn driven one cycle later by the Bi-Directional Data Buffer 840 and Read Data 812 arrive as expected at the Memory Controller 810 at T9 880 (labeled “Read data at the memory controller”). The Memory Controller 810 is accounting for (and only aware of) the latency of eight cycles it tried to program into the DRAM 820 and one cycle latency it is expecting from the Interface Bridge 830, hence the Memory Controller 810 expect to receive the read data from the DRAM 820 nine cycles after it issues the read command. Therefore, the standard JEDEC RDIMM read operation is supported and the read operation completes successfully without any changes, or at least without any significant changes, to the memory controller.

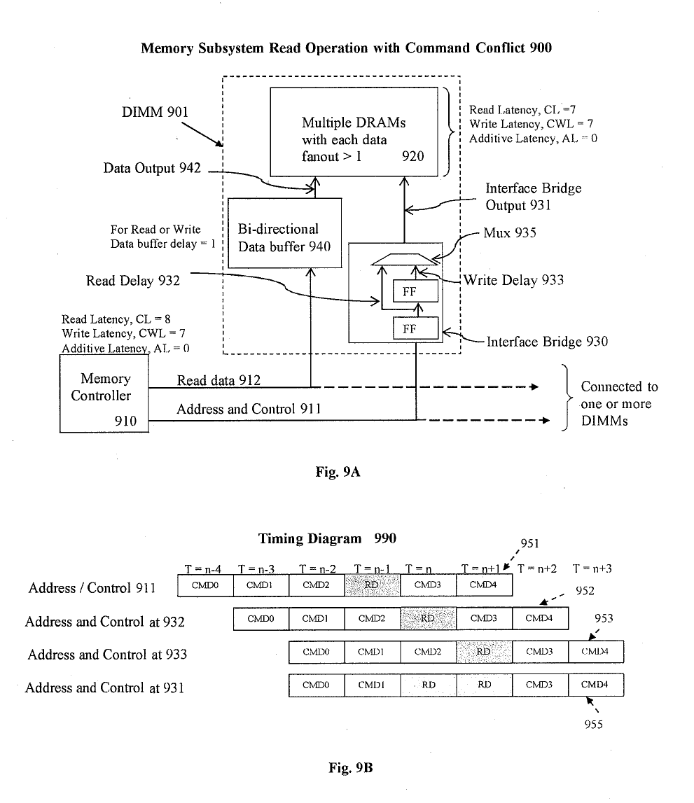

In accordance with one embodiment, a Memory Subsystem Read Operation with Command Conflict 900 is shown in FIG. 9. The memory subsystem includes a memory module DIMM 901 that is coupled to a Memory Controller 910. The memory access and operation of the memory module DIMM 901 is similar to the memory access and operation of DIMM 701 and DIMM 801 as described above, and therefore will not be repeated. However, it is possible under certain circumstances to have a command conflict depending on how the Interface Bridge 930 interact or respond to various commands from the Memory Controller 910. FIG. 9 schematically illustrates operation of an example interface bridge that includes simple latency delay logic in accordance with one embodiment described herein. An example case when the system memory controller issues back-to-back commands. In this case there will be a command collision at the output of the Interface Bridge 930 between the RD command at T=n−1 at wire 932, and the command issued at the previous clock cycle T=n−2 at wire 933. This collision is depicted in the Timing Diagram 990. The Interface Bridge 930 outputs 2 consecutive cycles of the same RD command based on the description in FIG. 8. The multiplexer 935 selects the RD command on wire 932 at T=n to pass the RD command without a cycle delay, and at T=n+1 the multiplexer selects the RD command on wire 933 as indicated in FIG. 8. This causes the example Interface Bridge 930 to output the same RD command twice while blocking the command CMD2. This event is shown the timing diagram 955 in FIG. 9. For example, since one cycle latency is added for Read, but two cycles are added for Write command, the mux 935 will switch to Read Delay 932 at T=n, and to Write Delay 933 at T=n+1. However, at T=n+1, the RD command appears at Write Delay 933. Thus, RD command appears at the Interface Bridge Output 931 at T=n and T=n+1, and hence a command conflict.

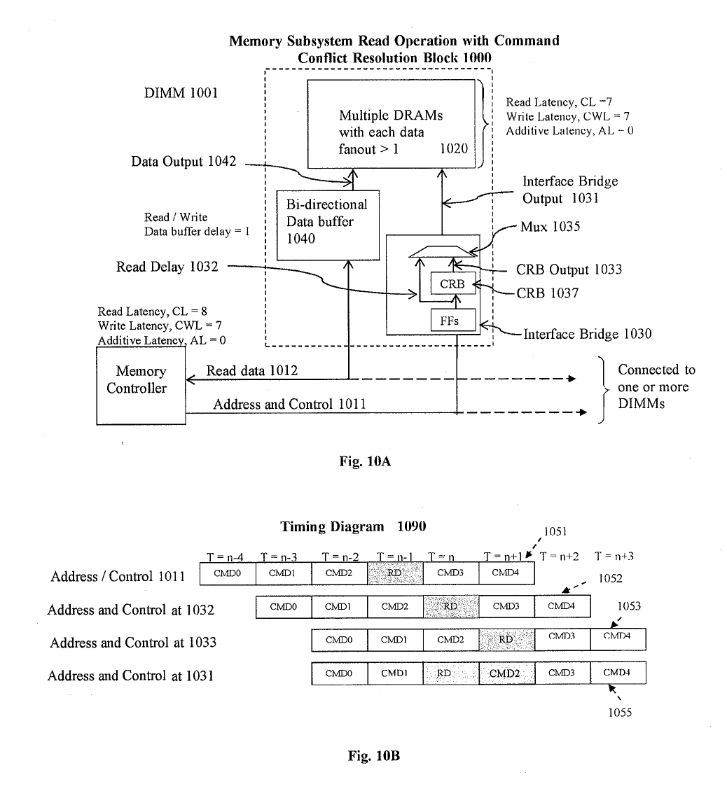

FIG. 10 schematically illustrates operation of an example interface bridge that includes a conflict resolution block in accordance with certain embodiments described herein. According to the example shown in FIG. 10, the command conflict is fixed by letting the Interface Bridge 1030 hold the command issued at T=n−1 for an additional cycle while passing the RD command as described in FIG. 9. The timing diagram in FIG. 10 shows the execution order of the consecutive commands received from the system memory controller by including a conflict resolution block CRB 1037 in the Interface Bridge 1030.

FIG. 7, FIG. 8 and FIG. 9 also show how the Serial Presence Detect (SPD) on a DIMM 1001 can be modified to support proper DIMM 1001 operation. The tRCD, the separation between row address select (RAS) to CAS, should be increased by two since the RAS command can be delayed by two cycles while there is no delay for the RD command. The tWRTRD, the write to read turn around time, should be increased by one since the WR command can be delayed by one clock cycle while there is no delay for the RD command.

As it has been demonstrated in FIG. 7, FIG. 8 FIG. 9, since a memory module, e.g., DIMM 1001, including an interface bridge according to certain embodiments described herein provides a memory controller interface that is identical or substantially identical to the JEDEC standard RDIMM interface, different types of DIMMs can be interoperable in the same memory subsystem. Moreover, according to certain systems and method described herein, an appropriate value can be determined for programming SPD for proper operation. The SPD value may be determined based on the inter-dependency between the Interface Bridge and the SPD, for example.

The following U.S. patents are incorporated in their entirety by reference herein: U.S. Pat. Nos. 7,289,386, 7,286,436, 7,442,050, 7,375,970, 7,254,036, 7,532,537, 7,636,274, 7,630,202, 7,619,893, 7,619,912, 7,811,097. The following U.S. patent applications are incorporated in their entirety by reference herein: U.S. patent application Ser. Nos. 12/422,912, 12/422,853, 12/577,682, 12/629,827, 12/606,136, 12/874,900, 12/422,925, 12/504,131, 12/761,179, and 12/815,339.

Various embodiments have been described above. Although this invention has been described with reference to these specific embodiments, the descriptions are intended to be illustrative of the invention and are not intended to be limiting. Various modifications and applications may occur to those skilled in the art without departing from the true spirit and scope of the invention as defined in the appended claims.

What is claimed is:

1. A method to interface a memory module to a memory controller, the memory module comprising a plurality of programmable memory devices and an interface bridge, the interface bridge configured to receive from the memory controller any one of a first read command, a first write command, and a first programming command, the method comprising:
the interface bridge determining a first and second latency delay values;
the interface bridge receiving a first read command issued by the memory controller to the memory module, wherein the first read command is stored by the interface bridge;
the interface bridge transmitting to the plurality of memory devices the first read command, wherein the transmitting of the first read command is delayed using the first latency delay value;
the interface bridge receiving a first write command issued by the memory controller to the memory module, wherein the first write command is stored by the interface bridge; and
the interface bridge transmitting to the plurality of memory devices the first write command, wherein the transmitting of the first write command is delayed using the second latency delay value.

2. The method of claim 1, wherein the first latency delay value corresponds to one clock cycle, and the second latency delay value corresponds to two clock cycles.

3. The method of claim 1, further comprising:
the interface bridge receiving a first programming command to program the plurality of programmable memory devices using a first latency value, wherein the first programming command includes the first latency value;
in response to the first programming command, the interface bridge generating a second latency value; and
the interface bridge programming the plurality of programmable memory devices using the second latency value.

4. The method of claim 3, wherein the first latency value is greater than the second latency value.

5. The method of claim 3, wherein the first latency value corresponds to any one of a first CAS latency value, a first read access latency value, and a first write access latency value.

6. The method of claim 3, wherein the memory module further comprising a bi-directional data buffer, the method further comprising:
the bidirectional data buffer receiving a first set of data signals from the memory controller in response to the first write command;
the bidirectional data buffer transmitting the first set of data signals to the plurality of programmable memory devices, wherein the transmitting of the first set of data signals to the plurality of programmable memory devices is delayed using a third latency delay value;
the bidirectional data buffer receiving a second set of data signals from the plurality of programmable memory devices in response to the first read command; and
the bidirectional data buffer transmitting the second set of data signals to the memory controller, wherein the transmitting of the second set of data signals to the memory controller is delayed using the third latency delay value.

7. The method of claim 6, wherein the third latency delay value corresponds to one clock cycle.

8. The method of claim 6, the method further comprising:
the plurality of programmable memory devices transmitting the second set of data signals to the bidirectional data buffer in response to the delayed first read command received from the interface bridge and based on the programmed second latency value.

9. The method of claim 6, the method further comprising:
the plurality of programmable memory devices receiving the first set of data signals from the bidirectional data buffer in response to the first write command received from the interface bridge.

10. The method of claim 6, wherein the difference between the first latency delay value and the second latency delay value equals the third latency delay value

11. A memory module comprising:
an interface bridge configured to (i) receive from a memory controller a first programming command to program a first latency value into a plurality of programmable memory devices, the first programming command includes the first latency value, (ii) generate a second latency value, wherein the second latency value is less than the first latency value, and (iii) program the second latency value into the plurality of programmable memory devices.

12. The memory module of claim 11, wherein the interface bridge is further configured to (i) receive a memory command from the memory controller, and (ii) transmit the received memory command to the plurality of programmable memory devices based on one of a first latency delay value and a second latency delay value, wherein the interface bridge delays the transmission of the received memory command based on the first latency delay value when the received memory command corresponds to a first read command issued by the memory controller and received by the interface bridge, and wherein the interface bridge delays the transmission of the received memory command based on the second latency delay value when the received memory command corresponds to a first write command issued by the memory controller and received by the interface bridge.

13. The memory module of claim 12, wherein the first latency delay value corresponds to one clock cycle and the second latency delay value corresponds to two clock cycles.

14. The memory module of claim 12, further comprising:
a bidirectional data buffer configured to (i) receive a first set of data signals, wherein the memory controller transmits the first set of data signals corresponding to the first write command, (ii) transmit the first set of data signals to the plurality of programmable memory devices using a third latency delay value, wherein the plurality of programmable memory devices receive the first set of data signals in response to the delayed first write command received from the interface bridge, (iii) receive a second set of data signals, wherein the plurality of programmable memory devices transmits the second set of data signals in response to the delayed first read command received by from the interface bridge and the programmed second latency value, and (iv) transmit the second set of data signals to the memory controller using the third latency delay value.

15. The memory module of claim 14, wherein the third latency delay value corresponds to one clock cycle.

16. The memory module of claim 14, wherein the third latency delay value equals the difference between the first and second latency delay values.

17. A method to interface a memory controller to a first and second memory modules, the first memory module comprising a first plurality of programmable memory devices and a first interface bridge, the first interface bridge configured to receive from the memory controller any one of a first read command and a first write command, the second memory module comprising a second plurality of programmable memory devices and a second interface bridge, the second interface bridge configured to receive from the memory controller any one of a second read command and a second write command, the method comprising:
determining a first latency delay value for the first read command, wherein the first read command is (i) issued by the memory controller to the first memory module, and (ii) stored by the first interface bridge;
the first interface bridge transmitting the first read command to the first plurality of programmable memory devices, wherein the transmitting of the first read command to the first plurality of programmable memory devices is delayed using the first latency delay value;
determining a second latency delay value for the first write command, wherein the first write command is (i) issued by the memory controller to the first memory module, and (ii) stored by the first interface bridge;
the first interface bridge transmitting the first write command to the first plurality of programmable memory devices, wherein the transmitting of the first write command to the first plurality of programmable memory devices is delayed using the second latency delay value;
the second interface bridge receiving and storing any one of the second read command and the second write command, wherein the memory controller issues any one of the second read command and the second write command to the second memory module; and
the second interface bridge transmitting any one of the second read command and the second write command to the second plurality of programmable memory devices, wherein the transmitting of any one of the second read command and the second write command to the second plurality of programmable memory devices is delayed using a third latency delay value.

18. The method of claim 17, wherein the first latency delay value corresponds to one clock cycle, the second latency delay value corresponds to two clock cycles, and the third latency delay value corresponds to one clock cycle.

19. The method of claim 17, wherein the memory controller issues a first command to program a first latency value into the first plurality of programmable memory devices, the first command includes the first latency value, the method further comprising:
the first interface bridge receiving the first command from the memory controller;
the first interface bridge generating a second latency value, wherein the second latency value is less than the first latency value; and
the first interface bridge programming the first plurality of programmable memory devices using the second read latency value.

20. The method of claim 19, wherein the memory controller issues a second command to program the first latency value into the second plurality of programmable memory devices, the second command includes the first latency value, the method further comprising:
the second interface bridge receiving the second command from the memory controller;
the second interface bridge programming the second plurality of programmable memory devices using the first latency value;
the first plurality of programmable memory devices transmitting a first set of data signals in response to the delayed first read command received from the first interface bridge and the programmed second latency value; and
the second plurality of programmable memory devices transmitting a second set of data signals in response to the delayed second read command received from the second interface bridge and the programmed first latency value.
